(19) United States
(12) Patent Application Publication
(10) Pub. No.: US 2026/0355822 A1
(43) Pub. Date: Nov. 12, 2026

(54) PRODUCTION OF SILVER NANOPARTICLES BY GREEN SYNTHESIS USING HAZELNUT HUSK EXTRACT

(71) Applicants: BAHCESEHIR UNIVERSITESI, Besiktas/Istanbul (TR); PIRI REIS UNIVERSITESI, Tuzla/Istanbul (TR)

(72) Inventors: Ozan AKDOGAN, Tuzla/Istanbul (TR); Nilay GUNDUZ AKDOGAN, Tuzla/Istanbul (TR); Damla SIVRI, Konyaalti/Antalya (TR); Ali KUREL, Sisli/Istanbul (TR)

(21) Appl. No.: 19/137,087

(22) PCT Filed: Dec. 9, 2022
(86) PCT No.: PCT/TR2022/051466

§ 371 Date: Jun. 9, 2025

(51) Int. Cl. B22F 9/24; B01F 33/45

(52) U.S. Cl. CPC B22F 9/24; B01F 33/45; B22F 2202/05; B22F 2301/255; B22F 2304/05; B22F 2998/10; B22F 2999/00

(57) ABSTRACT

The invention relates to synthesis of nanoparticles from hazelnut husk extract by green synthesis with high efficiency. Use of chemical is limited in the present invention and therefore the synthesis of nanoparticles is provided by green chemistry in the present invention. Said hazelnut may be Corylus and said hazelnut husk may be cob or shell of the hazelnut. In an embodiment of the invention said Corylus may be Corylus colurna, Corylus americana Corylus avellana, Corylus avellana var. avellana, Corylus avellana var. pontica, Corylus chinensis, Corylus colchica, Corylus x colurnoides, Corylus cornuta, Corylus cornuta ssp. californica, Corylus cornuta ssp. cornuta, Corylus fargesii, Corylus ferox, Corylus ferox var. ferox, Corylus ferox var. thibetica, Corylus heterophylla, Corylus heterophylla var. heterophylla, Corylus heterophylla var. sutchuensis, Corylus jacquemontii, Corylus maxima, Corylus potaninii, Corylus sieboldiana, Corylus sieboldiana var. mandshurica, Corylus sieboldiana var. sieboldiana, Corylus wangii, Corylus wulingensis or Corylus yunnanensis.

### TECHNICAL FIELD

The invention relates to synthesis of nanoparticles from hazelnut husk extract by green synthesis with high efficiency. Said hazelnut may be Corylus and said hazelnut husk may be cob or shell of the hazelnut. In an embodiment of the invention said Corylus may be Corylus colurna, Corylus americana Corylus avellana, Corylus avellana var. avellana, Corylus avellana var. pontica, Corylus chinensis, Corylus colchica, Corylus x colurnoides, Corylus cornuta, Corylus cornuta ssp. californica, Corylus cornuta ssp. cornuta, Corylus fargesii, Corylus ferox, Corylus ferox var. ferox, Corylus ferox var. thibetica, Corylus heterophylla, Corylus heterophylla var. heterophylla, Corylus heterophylla var. sutchuensis, Corylus jacquemontii, Corylus maxima, Corylus potaninii, Corylus sieboldiana, Corylus sieboldiana var. mandshurica, Corylus sieboldiana var. sieboldiana, Corylus wangii, Corylus wulingensis or Corylus yunnanensis.

### PRIOR ART

A nanoparticle (NP) is a small particle that ranges between 1 to 100 nanometers in size. Undetectable by the human eye, nanoparticles (NPs) can exhibit significantly different physical and chemical properties to their larger material counterparts. The definition given by the European Commission states that the particle size of at least half of the particles in the number size distribution must measure 100 nm or below. Most nanoparticles are made up of only a few hundred atoms [1].

NPs are broadly divided into various categories depending on their morphology, size and chemical properties such as carbon-based NPs, metal NPs, ceramics NPs, semiconductor NPs, polymeric NPs and lipid-based NPs.

Fullerenes and carbon nanotubes (CNTs) represent two major classes of carbon-based NPs. Fullerenes contain nanomaterial that are made of globular hollow cage such as allotropic forms of carbon. They have created noteworthy commercial interest due to their electrical conductivity, high strength, structure, electron affinity, and versatility. These materials possess arranged pentagonal and hexagonal carbon units, while each carbon is sp² hybridized. CNTs are elongated, tubular structure, 1-2 nm in diameter. These can be predicted as metallic or semiconducting reliant on their diameter telicity. These are structurally resembling to graphite sheet rolling upon itself. The rolled sheets can be single, double or many walls and therefore they named as single-walled (SWNTs), double-walled (DWNTs) or multi-walled carbon nanotubes (MWNTs), respectively. They are widely synthesized by deposition of carbon precursors especially the atomic carbons, vaporized from graphite by laser or by electric arc on to metal particles. Lately, they have been synthesized via chemical vapor deposition (CVD) technique. Due to their unique physical, chemical and mechanical characteristics, these materials are not only used in pristine form but also in nanocomposites for many commercial applications such as fillers, efficient gas adsorbents for environmental remediation, and as support medium for different inorganic and organic catalysts [2].

The term metal nanoparticles are used to described nanosized metals with dimensions (length, width or thickness) within the size range 1-100 nm. The existence of metallic nanoparticles in solution was first recognized by Faraday in 1857 and a quantitative explanation of their color was given by Mie in 1908. Metal NPs are purely made of the metal's precursors. Due to well-known localized surface plasmon resonance (LSPR) characteristics, these NPs possess unique optoelectrical properties. NPs of the alkali and noble metals i.e. Cu, Ag and Au have a broad absorption band in the visible zone of the electromagnetic solar spectrum. The facet, size and shape controlled synthesis of metal NPs is important in present day cutting-edge materials. Due to their advanced optical properties, metal NPs find applications in many research areas. The main characteristics of metal NPs are large surface-area-to-volume ratio as compared to the bulk equivalents, large surface energies due to the transition between molecular and metallic states providing specific electronic structure (local density of states LDOS), plasmon excitation, quantum confinement, short range ordering, increased number of kinks, a large number of low-coordination sites such as corners and edges, having a large number of “dangling bonds” and consequently specific and chemical properties and the ability to store excess electrons [3].

Ceramic nanoparticle is a type of nanoparticle that is composed of ceramics, which are generally classified as inorganic, heat-resistant, nonmetallic solids that can be made of both metallic and nonmetallic compounds. The material offers unique properties. Macroscale ceramics are brittle and rigid and break upon impact. However, Ceramic nanoparticles take on a larger variety of functions, including dielectric, ferroelectric, piezoelectric, pyroelectric, ferromagnetic, magnetoresistive, superconductive and electro-optical. Ceramic nanoparticles were discovered in the early 1980s. They were formed using a process called sol-gel which mixes nanoparticles within a solution and gel to form the nanoparticle. Later methods involved sintering (pressure and heat, .e. g hot isostatic pressing). The material is so small that it has basically no flaws. Larger scale materials have flaws that render them brittle. In 2014 researchers announced a lasering process involving polymers and ceramic particles to form a nanotruss. This structure was able to recover its original form after repeated crushing. Ceramic nanoparticles have been used as drug delivery mechanism in several diseases including bacterial infections, glaucoma, and most commonly, chemotherapy delivery in experimental cancer treatment [4].

Semiconductor NPs are semiconductor materials at nanoscale. These semiconductor NPs exhibit unique optoelectronic and magnetic properties due to their extremely small size (1-20 nm), high surface area, and quantum size effects. These are also known as quantum dots and have interesting applications in a wide array of areas such as LEDs, diodes, transistors, lasers, solar cells, medical imaging, and quantum computing. The characteristic properties of these semiconductor NPs or quantum dots are highly dependent on their size and shape. Because of their extremely small size, they are often considered as “artificial atoms,” since they have unique, discrete, and definitive electronic states as can be seen for the naturally occurring atoms/molecules. Moreover, a range of semiconductor NPs have been employed in water-splitting applications as they have appropriate bandgap and band-edge positions [5].

Polymeric nanoparticles (NPs) are colloidal particles with size ranging from 1 to 100 nm. They are comprised of active pharmaceutical ingredients that are within/adsorbed macromolecular substances (polymer). Due to quantum size effects, polymeric NPs affect their toxicity which are attributed to oxidative stress, cytotoxicity, and genotoxicity. Nanodiamonds have become a subject of bio research due to their attractive properties. Polymeric NPs have been used to remove toxic heavy metals. Multilayered NPs, functionalized inorganic or organic polymeric materials, coatings and hydrogels have revealed their potential for environmental and communal health applications. Polymer-NP composite materials have exclusive characteristics, such as high mechanical strength, good electrical conductivity, optical and thermal properties. New fluorescent nanomaterials, inspired from the fields of polymeric drug delivery vehicles and advanced fluorophores, can combine superior brightness with biodegradability and low toxicity [6].

Lipid-based nanoparticles (LNPs) are nanoparticles composed of lipids. They are a novel pharmaceutical drug delivery system (and part of nanoparticle based drug delivery), and a novel pharmaceutical formulation. LNPs as a drug delivery vehicle were first approved in 2018 for the siRNA drug Onpattro. LNPs became more widely known in late 2020, as some COVID-19 vaccines that use RNA vaccine technology coat the fragile mRNA strands with PEGylated lipid nanoparticles as their delivery vehicle. A lipid nanoparticle is typically spherical with an average diameter between 10 and 1000 nanometers. Solid lipid nanoparticles possess a solid lipid core matrix that can solubilize lipophilic molecules. The lipid core is stabilized by surfactants (emulsifiers). The emulsifier used depends on administration routes and is more limited for parenteral administrations. The term lipid is used here in a broader sense and includes triglycerides (e.g. tristearin), diglycerides (e.g. glycerol bahenate), monoglycerides (e.g. glycerol monostearate), fatty acids (e.g. stearic acid), steroids (e.g. cholesterol), and waxes (e.g. cetyl palmitate). All classes of emulsifiers (with respect to charge and molecular weight) have been used to stabilize the lipid dispersion. It has been found that the combination of emulsifiers might prevent particle agglomeration more efficiently [7].

Nanoparticles can be synthesized using a variety of techniques such as coprecipitation, hydrothermal synthesis, inert gas condensation, sputtering, microemulsion, microwave, laser ablation, sol-gel, ultrasound, spark discharge, template synthesis and biological synthesis. Dry particles and nanoparticles in liquid dispersion are synthesized by these techniques. Nanostructures can be generated by building from atoms or by reducing the size from microparticle to nanoparticle.

Coprecipitation technique involves the simultaneous occurrence of nucleation, growth, coarsening, and/or agglomeration processes. Coprecipitation technique is not applicable to uncharged species. Trace impurities may also get precipitated with the product in this technique. since this technique takes a very long time, it causes time consuming. This technique has batch-to-batch reproducibility problems. In addition, this method does not work well if the reactants have very different precipitation rates.

The hydrothermal technique is an action of water at elevated temperature and pressure in bringing about changes in the earth's crust leading to the creation of rocks and minerals. The hydrothermal synthesis is a route to unique condensed material, including nanometer particles, gels, thin films, distinguished helical and chiral structures, and particularly stacking-sequence materials. Hydrothermal technique of single crystals depends on the solubility of minerals in hot water under high pressure. The crystal growth is performed in an apparatus consisting of a steel pressure vessel called an autoclave, in which a material is supplied along with water. A gradient of temperature is maintained at the opposite ends of the growth chamber so that the hotter end dissolves the material and the cooler end causes seeds to take additional growth. On the other hand, the hydrothermal technique requires expensive autoclaves, and there are some safety issues during the reaction process. In addition, it is impossible to observe the reaction process of the hydrothermal technique.

Inert gas condensation (IGC) is the most widely used method for the synthesis of metal nanoparticles. In IGC, metals are evaporated in an ultrahigh vacuum chamber filled with helium or argon gas at very high pressure. The evaporated metal atoms lose their kinetic energy by collisions with the gas and condense into small particles. These particles then grow by Brownian coagulation and coalescence and finally form nanocrystals. Although the gas condensation method, including variations, has been widely employed to prepare a variety of metallic and ceramic materials, quantities have so far been limited to a laboratory scale. The method is extremely slow. The quantities of metals are below 1 g/day, while quantities of oxides can be as high as 20 g/day for simple oxides, such as CeO₂ or ZrO₂. These quantities are sufficient for materials testing but not for industrial production.

Sputtering is an ejection of atoms from the surface of a material (the target) by bombardment with energetic particles, and a momentum transfer process in which atoms from a cathode/target are driven off by bombarding ions. Sputtered atoms travel until they strike a substrate, where they deposit to form the desired layer. Many variations can be introduced in the ion sputtering synthesis route by altering the magnetic field or radio frequency (RF) depending on the properties of nanoparticles which are to be synthesized. On the other hand, sputtering rates are low compared to those that can be attained in thermal evaporation, and targets are often expensive. Most of the energy incident on the target becomes heat in sputtering, which must be removed. In reactive sputter deposition, the gas composition must be carefully controlled to prevent contamination of-the sputtering target.

The microemulsion technique is one of the ideal techniques for the preparation of inorganic nanoparticles, yet the mechanism of nanoparticle formation in the microemulsion has not yet been well understood. However, some researchers have suggested a mechanism for nanoparticle synthesis within microemulsions. When the microemulsion material, including reactants, are mixed together, reactant exchange takes place during the collision of water droplets in the microemulsion. The reactant exchange is too fast, and a precipitation reaction occurs in the nanodroplets, which is followed by nucleation growth and coagulation of primary particles, resulting in the final nanoparticles surrounded by water and/or stabilized by surfactants. However, microemulsion formation requires large amounts of surfactant and/or cosurfactant, and these at high concentrations are generally irritating. External factors, such as temperature and pH, influence the stability of microemulsions. The microemulsion technique has limited solubilizing capacity for substances with high melting points.

Microwave technique is popular in areas ranging from biochemical processes to nanotechnology. Chemical reactions are often faster than traditional convection heating methods and have high yields and fewer side products. Microwave reactors provide excellent control over reaction mixing, withstanding high temperatures and pressures, and demonstrate reproducibility from reaction to reaction. Microwave assisted techniques provide improved engineering control over the separation of the nucleation and growth stages of nanomaterial synthesis when the reaction is initiated from room temperature. Microwave-assisted heating could possibly provide some selectivity in activating the nanomaterial precursor materials, which is important for scalability. Microwave synthesis has the potential to selectively heat either the solvent or the precursor molecules for nanomaterials preparation.

Laser ablation is the technique of removing material from a solid surface by irradiating it with a laser beam. At low laser flux, the material is heated by the absorbed laser energy and evaporates or sublimates. At high laser flux, the material is typically converted to plasma. Usually, laser ablation refers to removing material with a pulsed laser, but it is possible to ablate material with a continuous wave laser beam if the laser intensity is high enough.

Sol-gel is a technique for producing solid materials from small molecules. In this chemical procedure, the sol (or solution) gradually evolves toward the formation of a gel-like diphasic system containing both a liquid phase and a solid phase, the morphologies of which range from discrete particles to continuous polymer networks. Ultrafine and uniform ceramic powders can be formed by precipitation. These powders of single and multicomponent composition can be produced on a nanoscale particle size for dental and biomedical applications. However, this technique is relatively longer in reaction time, and organic solvents that are used in the technique may be harmful to the human body.

Ultrasound has become an important tool for the synthesis of nanoparticles. When liquids are irradiated with ultrasonic irradiation, ultrasonic cavitation will form. Ultrasonic cavitation produces a variety of physical and chemical effects, such as high temperature, pressure, and cooling rate, which provides a unique environment for chemical reactions under extreme conditions. Ultrasound is a fine method for the preparation of nanoparticles with controllable morphologies. However, heat-sensitive materials cannot withstand acoustic cavitation in this technique which is an energy intensive process. In addition, scaleup is difficult by this technique. Although it is a method which yields nanoparticles at ambient temperature conditions, the energy supply needed to carry out sonochemical synthesis is quite high, and therefore the yield per unit energy supplied is low.

The synthesis of nanoparticles using spark discharge is a promising method for low-cost industrial scale nanofabrication of advanced materials. An electric spark is an abrupt electrical discharge that occurs when a sufficiently high electric field creates an ionized, electrically conductive channel through a normally insulating medium, often air or other gases or gas mixtures. However, low production rate of spark discharge technique has been a limiting factor.

With the increasing emphasis on green chemistry, it is becoming more important to develop an environmentally friendly, facile method for the synthesis of nanoparticles. It has been reported that template synthesis is one of the most promising methods for the preparation of monodispersed inorganic nanoparticles, in which the uniform void spaces of porous materials are used as hosts to confine the synthesized nanoparticles as guests. The role of the template is twofold. First, it allows the reproduction of the structure with the best possible reproducibility and plays the role of a skeleton in order to organize the different functions of a device, the active components, and the different interfaces.

Biological synthesis of nanoparticles is a green chemistry approach that interconnects nanotechnology and biotechnology. However, despite the stability, biological nanoparticles are not monodispersed, and the rate of synthesis is slow. The concentration of synthesized macromolecules or components involved in the nucleation of particles varies with time and prolongs the nucleation period, which causes the polydispersity of nanoparticles and subsequent decreased rate of synthesis. In order to overcome these problems, several methods, such as microbial cultivation methods and the extraction techniques, have to be optimized, and a combinatorial approach, such as photobiological methods, may be used. Cellular, biochemical, and molecular mechanisms that mediate the synthesis of biological nanoparticles should be studied in detail to increase the rate of synthesis and improve the properties of the nanoparticles. Owing to the rich biodiversity of plants and microbes, the potential as biological materials for nanoparticle synthesis is yet to be fully explored [8].

Corylus colurna, the Turkish hazel or Turkish filbert, is a deciduous tree native to southeast Europe and southwest Asia, from the Balkans through northern Turkey to northern Iran. It is also found growing wild in the forests of Western Himalayan range in the north Indian state of Himachal Pradesh particularly in the temperate regions of districts of Kullu, Shimla, Kinnaur district and Chamba district [9].

In the prior art, U.S. Pat. No. 9,144,544B1 relates to synthesis of silver nanoparticles from Pimpinella anisum seeds. The synthesis of silver nanoparticles from Pimpinella anisum L seeds includes providing a silver nitrate (AgNO₃) solution, providing an extract of Pimpinella anisum L. plant seeds, and combining the silver nitrate solution with the extract of the Pimpinella anisum L. plant seeds to produce silver nanoparticles. The synthesis of silver nanoparticles from Pimpinella anisum L. seeds does not require toxic chemical solvents.

U.S. Pat. No. 10,059,601B1 relates to synthesis of silver nanoparticles from Abelmoschus esculentus extract. The synthesis of silver nanoparticles from plant extract includes providing a solution including silver nitrate; providing an aqueous extract of the Abelmoschus esculentus (Okra) plant or plant part; mixing the silver nitrate solution and the extract solution to form an aqueous mixture; and resting the aqueous mixture for a period of time to form silver nanoparticles (AgNPs). The resulting silver nanoparticles demonstrate antimicrobial activity against both gram-positive and gram-negative pathogens.

According to the problems in the prior art such as requiring larger space, high power, rapid rise of environmental temperature, being hazardous and costly, not being easily accessible, and having low yield rate, developments in related art is needed.

### BRIEF DESCRIPTION AND OBJECTIVES OF THE INVENTION

Synthesis of nanoparticles from hazelnut husk extract by green synthesis with high efficiency is provided. Said hazelnut may be Corylus and said hazelnut husk may be cob or shell of the hazelnut. In an embodiment of the invention said Corylus may be Corylus colurna, Corylus americana Corylus avellana, Corylus avellana var. avellana, Corylus avellana var. pontica, Corylus chinensis, Corylus colchica, Corylus x colurnoides, Corylus cornuta, Corylus cornuta ssp. californica, Corylus cornuta ssp. cornuta, Corylus fargesii, Corylus ferox, Corylus ferox var. ferox, Corylus ferox var. thibetica, Corylus heterophylla, Corylus heterophylla var. heterophylla, Corylus heterophylla var. sutchuensis, Corylus jacquemontii, Corylus maxima, Corylus potaninii, Corylus sieboldiana, Corylus sieboldiana var. mandshurica, Corylus sieboldiana var. sieboldiana, Corylus wangii, Corylus wulingensis or Corylus yunnanensis. An object of the present invention is synthesizing nanoparticles by green chemistry. In the present invention hazelnut husk is used to synthesize nanoparticles. Use of chemical is limited in the present invention and therefore the synthesis of nanoparticles is provided by green chemistry in the present invention.

Another object of the invention is recycling of hazelnut husk. In the invention, nanoparticles are synthesized from hazelnut husk extract by green synthesis. Therefore, the recycling of hazelnut husk is provided.

Another object of the invention is providing an easily accessible and low-cost method to synthesize nanoparticles. In the invention, nanoparticles are synthesized from hazelnut husk extract. Hazelnut husk, which is discarded as tons of waste every year, is recycled with the invention. Therefore, an easily accessible and low-cost method is provided by using waste husk.

Another object of the invention is synthesizing nanoparticles with high yield. In the invention, nanoparticles are synthesized from hazelnut husk extract which increases yield of the reaction.

An easily accessible and low-cost method for synthesis of nanoparticles from hazelnut husk extract by green synthesis, and recycling hazelnut husk is provided by the invention.

### BRIEF DESCRIPTION OF THE FIGURES

FIG. 1. Nanoparticle powder yield graph based on size and mass concentration.

### DETAILED DESCRIPTION OF THE INVENTION

The invention is related to synthesis of nanoparticles from hazelnut husk extract by green synthesis. Said hazelnut may be Corylus and said hazelnut husk may be cob or shell of the hazelnut. In an embodiment of the invention said Corylus may be Corylus colurna, Corylus americana Corylus avellana, Corylus avellana var. avellana, Corylus avellana var. pontica, Corylus chinensis, Corylus colchica, Corylus x colurnoides, Corylus cornuta, Corylus cornuta ssp. californica, Corylus cornuta ssp. cornuta, Corylus fargesii, Corylus ferox, Corylus ferox var. ferox, Corylus ferox var. thibetica, Corylus heterophylla, Corylus heterophylla var. heterophylla, Corylus heterophylla var. sutchuensis, Corylus jacquemontii, Corylus maxima, Corylus potaninii, Corylus sieboldiana, Corylus sieboldiana var. mandshurica, Corylus sieboldiana var. sieboldiana, Corylus wangii, Corylus wulingensis or Corylus yunnanensis. In the invention hazelnut husks extract is used for synthesis of nanoparticles.

In the invention, a precursor material, which is a nitrate compound is used to synthesize nanoparticles. Said precursor material may be; silver nitrate (AgNO₃), thallium (I) nitrate (TlNO₃), palladium (II) nitrate (Pd(NO₃)₂), erbium (III) nitrate pentahydrate (Er(NO₃)₃·5H₂O), copper (II) nitrate hemi(pentahydrate) (Cu(NO₃)₂·2.5H₂O), gallium(III) nitrate hydrate (Ga(NO₃)₃·xH₂O), ammonium cerium (IV) nitrate (Ce(NH₄)₂(NO₃)₆), samarium (III) nitrate hexahydrate (Sm(NO₃)₃·6H₂O), holmium (III) nitrate pentahydrate (Ho(NO₃)₃·5H₂O), europium (III) nitrate hydrate (Eu(NO₃)₃·xH₂O), cobalt (II) nitrate hexahydrate (Co(NO₃)₂·6H₂O), bismuth (III) nitrate pentahydrate (Bi(NO₃)₃·5H₂O), nickel (II) nitrate hexahydrate (Ni(NO₃)₂·6H₂O), gadolinium (III) nitrate hexahydrate (Gd(NO₃)₃·6H₂O), neodymium (III) nitrate hexahydrate (Nd(NO₃)₃·6H₂O), barium nitrate (Ba(NO₃)₂), strontium nitrate (Sr(NO₃)₂), lead (II) nitrate (Pb(NO₃)₂), zinc nitrate hydrate (Zn(NO₃)₂·xH₂O), europium (III) nitrate pentahydrate (Eu(NO₃)₃·5H₂O), tetraammineplatinum (II) nitrate ([Pt(NH₃)₄](NO₃)₂), magnesium nitrate hexahydrate (Mg(NO₃)₂·6H₂O), mercury (II) nitrate monohydrate (Hg(NO₃)₂·H₂O), manganese (II) nitrate hydrate (Mn(NO₃)₂·xH₂O), lutetium (III) nitrate hydrate (Lu(NO₃)₃·xH₂O), yttrium (III) nitrate hexahydrate (Y(NO₃)₃·6H₂O), neodymium (III) nitrate hydrate (Nd(NO₃)₃·xH₂O), iron (III) nitrate nonahydrate (Fe(NO₃)₃·9H₂O), yttrium(III) nitrate tetrahydrate (Y(NO₃)₃·4H₂O), lanthanum (III) nitrate hexahydrate (La(NO₃)₃·6H₂O), lanthanum (III) nitrate hydrate (La(NO₃)₃·xH₂O), praseodymium (III) nitrate hexahydrate (Pr(NO₃)₃·6H₂O), scandium (III) nitrate hydrate (Sc(NO₃)₃·xH₂O), terbium (III) nitrate hexahydrate (Tb(NO₃)₃·6H₂O), ytterbium (III) nitrate pentahydrate (Yb(NO₃)₃·5H₂O), aluminum nitrate nonahydrate (Al(NO₃)₃·9H₂O), zirconyl nitrate solution (ZrO(NO₃)₂), cesium nitrate (CsNO₃), ammonium nitrate (NH₄NO₃), rubidium nitrate (RbNO₃), terbium (III) nitrate pentahydrate (Tb(NO₃)₃·5H₂O), indium (III) nitrate hydrate (In(NO₃)₃·xH₂O), cadmium nitrate tetrahydrate (Cd(NO₃)₂·4H₂O), cerium(III) nitrate hexahydrate (Ce(NO₃)₃·6H₂O), calcium nitrate hydrate (Ca(NO₃)₂·xH₂O), copper (II) nitrate hydrate (Cu(NO₃)₂·xH₂O), chromium (III) nitrate nonahydrate (Cr(NO₃)₃·9H₂O) or dysprosium (III) nitrate hydrate (Dy(NO₃)₃·xH₂O).

First of all, hazelnut husk extract is prepared to produce nanoparticles. The preparation method of husk extract comprises following steps;
i. hazelnut husks are washed with water, and dried,
ii. adding dried hazelnut husks and water, which have an impact on size of the nanoparticles and the yield, into a beaker to get a mixture, and heating the mixture until color of the DI water turns to yellowish,
iii. filtering the mixture to obtain extract of husks.

In an embodiment of the invention, the preparation method of husk extract comprises following steps;
i. hazelnut husks are washed with de-ionized (DI) water, and dried,
ii. adding dried hazelnut husks and DI water, which have an impact on size of the nanoparticles and the yield, into a beaker to get a mixture, and heating the mixture at 100 °C until color of the DI water turns to yellowish,
iii. filtering the mixture with filter paper to obtain extract of husks.

A method for synthesis of nanoparticles from hazelnut husk extract comprises following steps;
i. adding de-ionized (DI) water and precursor material into a beaker, and mixing it on a magnetic stirrer without heating,
ii. adding hazelnut husk extract to the solution drop wise, and the solution is mixed until color of the solution turns to a brown-black color,
iii. after the synthesis was completed, the silver nanoparticles were centrifuged and after centrifugation, the waste liquid part remaining on the top was removed and ethanol was added, then the particle was put into the sonicator each time and this process was repeated 4-5 times,
iv. drying process was applied in an oven to get nanoparticles.

In an embodiment of the invention a method for synthesis of nanoparticles from hazelnut husk extract comprises following steps;
i. adding 100 ml of de-ionized (DI) water and 1 gram of precursor material into a beaker, and mixing for 1-3 minutes on a magnetic stirrer without heating,
ii. adding 1 g/29.5 ml (precursor/reducer) ratio to reduce the precursor. 29.5 ml hazelnut husk extract is added to the solution drop wise, and mixing the solution until color of the solution turns to a brown-black color,
iii. after the synthesis was completed, the silver nanoparticles were first placed in 15 ml falcon tubes and the falcon tubes were first placed in the centrifuge machine, used in range of 2500-4100 rpm, for 10 minutes and after centrifugation, the waste liquid part remaining on the top was carefully removed and ethanol was added, then the particle was put into the sonicator each time and this process was repeated 4-5 times,
iv. placing the nanoparticles on a petri dish and drying process was applied in an oven at 70 °C about 1 hour to get nanoparticles.

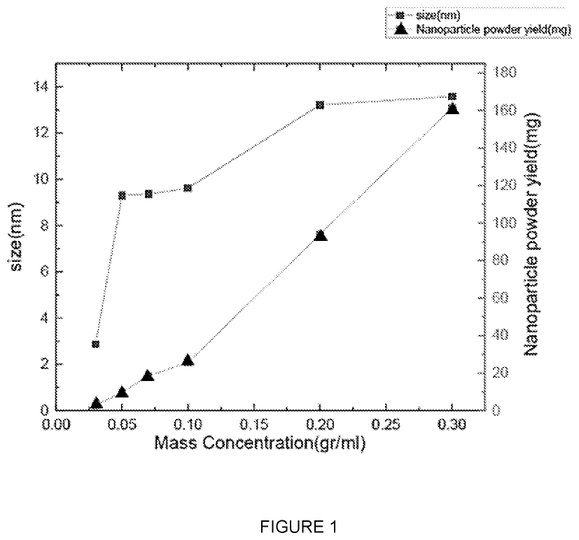

The dried silver nanoparticles can be stored in an empty glass tube. Using hazelnut husk extract for the synthesis of nanoparticles, increases the yield of the reaction. As shown in FIG. 1 synthesizing nanoparticles in different mass concentrations of hazelnut husk extract have an impact on silver nanoparticle size and nanoparticle powder yield. In graph nanoparticle powder yield and size increases with the increase of mass concentration. Ag nanoparticles form by the coalescence of Ag atoms resulted by the reduction of precursor. Presence of more atoms increases both the size and the yield of nanoparticles. Thus, In order to increase size of the nanoparticle and nanoparticle powder yield its needed an increase in reducing agent which is hazelnut husk extract.

### REFERENCES

[1] What are Nanoparticles? Definition, Size, Uses and Properties. (n.d.). TWI. https://www.twi-global.com/technical-knowledge/faqs/what-are-nanoparticles
[2] Khan, I., Saeed, K., & Khan, I. (2019). Nanoparticles: Properties, applications and toxicities. Arabian Journal of Chemistry, 12(7), 908-931. https://doi.org/10.1016/j.arabjc.2017.05.011
[3] Dreaden, E. C., Alkilany, A. M., Huang, X., Murphy, C. J., & El-Sayed, M. A. (2012). The golden age: gold nanoparticles for biomedicine. Chem. Soc. Rev., 41(7), 2740-2779. https://doi.org/10.1039/c1cs15237h
[4] Thomas, S., Harshita, B. S. P., Mishra, P., & Talegaonkar, S. (2015). Ceramic Nanoparticles: Fabrication Methods and Applications in Drug Delivery. Current Pharmaceutical Design, 21(42), 6165-6188. https://doi.org/10.2174/1381612821666151027153246
[5] Ali, S., Khan, I., Khan, S. A., Sohail, M., Ahmed, R., Rehman, A. U., Ansari, M. S., & Morsy, M. A. (2017). Electrocatalytic performance of Ni@Pt core-shell nanoparticles supported on carbon nanotubes for methanol oxidation reaction. Journal of Electroanalytical Chemistry, 795, 17-25. https://doi.org/10.1016/j.jelechem.2017.04.040
[6] Rao, J. P., & Geckeler, K. E. (2011). Polymer nanoparticles: Preparation techniques and size-control parameters. Progress in Polymer Science, 36(7), 887-913. https://doi.org/10.1016/j.progpolymsci.2011.01.001
[7] Rawat, M. K., Jain, A., & Singh, S. (2011). Studies on Binary Lipid Matrix Based Solid Lipid Nanoparticles of Repaglinide: in Vitro and in Vivo Evaluation. Journal of Pharmaceutical Sciences, 100(6), 2366-2378. https://doi.org/10.1002/jps.22435
[8] Rane, A. V., Kanny, K., Abitha, V., & Thomas, S. (2018). Methods for Synthesis of Nanoparticles and Fabrication of Nanocomposites. Synthesis of Inorganic Nanomaterials, 121-139. https://doi.org/10.1016/b978-0-08-101975-7.00005-1
[9] Arslan, M., (2005). Batι Karadeniz Bölgesindeki Türk Fιndιğι (Corylus colurna L.) Populasyonlarιnιn Ekolojik ve Silvikültürel Yönden İncelenmesi. Abant İzzet Baysal Üniv. Fen Bilimleri Enstitüsü, Y. Lisans Tezi, Basιlmamιş, Bolu.

1. A method for green synthesis of nanoparticles from hazelnut husk extract comprising the following steps;
i. adding de-ionized (DI) water and precursor material into a beaker, and mixing it on a magnetic stirrer without heating,
ii. adding hazelnut husk extract to the solution drop wise, and the solution is mixed until color of the solution turns to a brown-black color,
iii. after the synthesis was completed, the silver nanoparticles were centrifuged and after centrifugation, the waste liquid part remaining on the top was removed and ethanol was added, then the particle was put into the sonicator each time and this process was repeated 4-5 times, and
iv. drying process was applied in an oven to get nanoparticles.

2. The method according to claim 1, comprising the following steps;
i. adding 100 ml of de-ionized (DI) water and 1 gram of precursor material into a beaker, and mixing for 1-3 minutes on a magnetic stirrer without heating,
ii. adding 1 g/29.5 ml (precursor/reducer) ratio to reduce the precursor.29.5 ml hazelnut husk extract is added to the solution drop wise, and mixing the solution until color of the solution turns to a brown-black color,
iii. after the synthesis was completed, the silver nanoparticles were first placed in 15 ml falcon tubes and the falcon tubes were first placed in the centrifuge machine, used in range of 2500-4100 rpm, for 10 minutes and after centrifugation, the waste liquid part remaining on the top was carefully removed and ethanol was added, then the particle was put into the sonicator each time and this process was repeated 4-5 times, and
iv. placing the nanoparticles on a petri dish and drying process was applied in an oven at 70 °C about 1 hour to get nanoparticles.

3. The method according to claim 1, wherein the hazelnut husk extract is obtained by a method for extraction comprising the following steps;
i. hazelnut husks are washed with water, and dried,
ii. adding dried hazelnut husks and water, which have an impact on size of the nanoparticles and the yield, into a beaker to get a mixture, and heating the mixture until color of the DI water turns to yellowish, and
iii. filtering the mixture to obtain extract of husks.

4. The method according to claim 3, wherein the hazelnut husk extract is obtained by a method for extraction comprising the following steps;
i. hazelnut husks are washed with de-ionized (DI) water, and dried,
ii. adding dried hazelnut husks and DI water, which have an impact on size of the nanoparticles and the yield, into a beaker to get a mixture, and heating the mixture at 100 °C until color of the DI water turns to yellowish, and
iii. filtering the mixture with filter paper to obtain extract of husks.

5. The method according to claim 1, wherein the hazelnut is Corylus.

6. The method according to claim 5, wherein the Corylus is Corylus colurna, Corylus americana Corylus avellana, Corylus avellana var. avellana, Corylus avellana var. pontica, Corylus chinensis, Corylus colchica, Corylus x colurnoides, Corylus cornuta, Corylus cornuta ssp. californica, Corylus cornuta ssp. cornuta, Corylus fargesii, Corylus ferox, Corylus ferox var. ferox, Corylus ferox var. thibetica, Corylus heterophylla, Corylus heterophylla var. heterophylla, Corylus heterophylla var. sutchuensis, Corylus jacquemontii, Corylus maxima, Corylus potaninii, Corylus sieboldiana, Corylus sieboldiana var. mandshurica, Corylus sieboldiana var. sieboldiana, Corylus wangii, Corylus wulingensis or Corylus yunnanensis.

7. The method according to claim 1, wherein the precursor material is nitrate compound.

8. The method according to claim 7, wherein the nitrate compound is silver nitrate (AgNO₃), thallium (I) nitrate (TlNO₃), palladium (II) nitrate (Pd(NO3)2), erbium (III) nitrate pentahydrate (Er(NO₃)₃\hat{ }5H₂O), copper (II) nitrate hemi(pentahydrate) (Cu(NO₃)₂\hat{ }2.5H₂O), gallium(III) nitrate hydrate (Ga(NO₃)₃\hat{ }xH₂O), ammonium cerium (IV) nitrate (Ce(NH₄)₂(NO₃)₆), samarium (III) nitrate hexahydrate (Sm(NO₃)₃\hat{ }6H₂O), holmium (III) nitrate pentahydrate (Ho(NO₃)₃\hat{ }5H₂O), europium (III) nitrate hydrate (Eu(NO3)3\hat{ }xH2O), cobalt (II) nitrate hexahydrate (Co(NO3)2\hat{ }6H2O), bismuth (III) nitrate pentahydrate (Bi(NO3)3\hat{ }5H2O), nickel (II) nitrate hexahydrate (Ni(NO3)2\hat{ }6H2O), gadolinium (III) nitrate hexahydrate (Gd(NO3)3\hat{ }6H2O), neodymium (III) nitrate hexahydrate (Nd(NO3)3\hat{ }6H2O), barium nitrate (Ba(NO₃)₂), strontium nitrate (Sr(NO₃)₂), lead (II) nitrate (Pb(NO₃)₂), zinc nitrate hydrate (Zn(NO₃)₂\hat{ }xH₂O), europium (III) nitrate pentahydrate (Eu(NO₃)₃\hat{ }5H₂O), tetraammineplatinum (II) nitrate ([Pt(NH₃)₄](NO₃)₂), magnesium nitrate hexahydrate (Mg(NO₃)₂\hat{ }6H₂O), mercury (II) nitrate monohydrate (Hg(NO₃)₂\hat{ }H2O), manganese (II) nitrate hydrate (Mn(NO3)2\hat{ }xH2O), lutetium (III) nitrate hydrate (Lu(NO3)3\hat{ }xH2O), yttrium (III) nitrate hexahydrate (Y(NO3)3\hat{ }6H2O), neodymium (III) nitrate hydrate (Nd(NO3)3\hat{ }xH2O), iron (III) nitrate nonahydrate (Fe(NO3)3\hat{ }9H2O), yttrium(III) nitrate tetrahydrate (Y(NO3)3\hat{ }4H2O), lanthanum (III) nitrate hexahydrate (La(NO₃)₃\hat{ }6H₂O), lanthanum (III) nitrate hydrate (La(NO₃)₃\hat{ }xH₂O), praseodymium (III) nitrate hexahydrate (Pr(NO₃)₃\hat{ }6H₂O), scandium (III) nitrate hydrate (Sc(NO₃)₃\hat{ }xH₂O), terbium (III) nitrate hexahydrate (Tb(NO₃)₃\hat{ }6H₂O), ytterbium (III) nitrate pentahydrate (Yb(NO₃)₃\hat{ }5H₂O), aluminum nitrate nonahydrate (Al(NO3)3\hat{ }9H2O), zirconyl nitrate solution (ZrO(NO3)2), cesium nitrate (CsNO3), ammonium nitrate (NH4NO3), rubidium nitrate (RbNO3), terbium (III) nitrate pentahydrate (Tb(NO3)3\hat{ }5H2O), indium (III) nitrate hydrate (In(NO3)3\hat{ }xH2O), cadmium nitrate tetrahydrate (Cd(NO3)2\hat{ }4H2O), cerium(III) nitrate hexahydrate (Ce(NO₃)₃\hat{ }6H₂O), calcium nitrate hydrate (Ca(NO₃)₂\hat{ }xH₂O), copper (II) nitrate hydrate (Cu(NO₃)₂\hat{ }xH₂O), chromium (III) nitrate nonahydrate (Cr(NO₃)₃\hat{ }9H₂O) or dysprosium (III) nitrate hydrate (Dy(NO₃)₃\hat{ }xH₂O).

9. The method according to claim 1, wherein hazelnut husk is cob or shell of the hazelnut.
